(19) United States
(12) Patent Application Publication
(10) Pub. No.: US 2009/0184254 A1
(43) Pub. Date: Jul. 23, 2009

(54) ULTRAVIOLET SENSOR AND METHOD OF MANUFACTURING ULTRAVIOLET SENSOR

(76) Inventor: Noriyuki MIURA, Kanagawa (JP)

Correspondence Address: TAFT, STETTINIUS & HOLLISTER LLP, SUITE 1800, 425 WALNUT STREET, CINCINNATI, OH, 45202-3957, US

(21) Appl. No.: 12/343,907

(22) Filed: Dec. 24, 2008

(30) Foreign Application Priority Data
Jan. 22, 2008 (JP) 2008-011907

(51) Int. Cl. G01J 1/42

(52) U.S. Cl. 250/372

(57) ABSTRACT

An ultraviolet sensor capable of separately detecting amount of ultraviolet irradiation of two wavelength range of a UV-A wave and a UV-B wave is provided. The ultraviolet sensor includes: a pair of photodiodes in which a high concentration P-type diffusion layer formed by diffusing a P-type impurity with a high concentration and a high concentration N-type diffusion layer formed by diffusing an N-type impurity with a high concentration, which are formed in a first silicon semiconductor layer on an insulation layer, are opposed to each other with a low concentration diffusion layer, which is formed in a second silicon semiconductor layer thinner than the first silicon semiconductor layer by diffusing one of the P-type impurity or the N-type impurity with a low concentration, interposed therebetween; an interlayer insulation film which is formed on the first and second silicon semiconductor layers; a filter film which is formed on the interlayer insulation layer of one of the photodiodes and formed of a silicon nitride film transmitting rays of a wavelength range of the UV-A wave or a longer wave; and a sealing layer which covers the interlayer insulation film of the other of the photodiodes and the filter film and transmits rays of the wavelength range of the UV-B wave or a longer wave.

### CROSS-REFERENCE TO RELATED APPLICATIONS

This application claims priority under 35 U.S.C. §119 to Japanese Patent Application Serial No. JP 2008-011907 filed on Jan. 22, 2008, entitled “ULTRAVIOLET SENSOR AND METHOD OF MANUFACTURING ULTRAVIOLET SENSOR,” the disclosure of which is hereby incorporated by reference.

### RELATED ART

1. Field of the Invention

The present disclosure relates to an ultraviolet sensor using a photodiode capable of receiving rays containing an ultraviolet ray and generating current, as well as methods of manufacturing an ultraviolet sensor.

2. Description of the Related Art

Known ultraviolet sensors detect the intensity of an ultraviolet ray by forming a photodiode in which an N+ diffusion layer is formed in the pectinate shape of an “E” by diffusing an N-type impurity in a high concentration. Opposing comb portions of a P+ diffusion layer are formed in the pectinate shape of “π” by diffusing a P-type impurity with a high concentration. The opposing pectinate shapes are horizontally opposed to each other with an implanted oxide film interposed therebetween on a semiconductor wafer having an SOI (Silicon On Insulator) structure. This SOI structure is formed over a silicon semiconductor layer and has a thickness of approximately 150 nm. The silicon semiconductor layer is formed by diffusing an N-type impurity at a low concentration; applying predetermined voltage to wirings electrically connected to the N+ diffusion layer and the P+ diffusion layer; and, absorbing only the ultraviolet ray with a horizontal thin depletion layer formed between the N+ diffusion layer and the P+ diffusion layer. Examples of such a structure are disclosed in Japanese Patent Publication No. 7-162024.

Known visible ray sensors, such as those disclosed in Japanese Patent Publication No. 7-162024, prevent non-uniformity of an optical property caused due to the interference of incident light using the thickness of a light transmittable gel by forming a P+ diffusion layer on a surface of an N− diffusion layer. To form this structure, an N− diffusion layer is formed by diffusing an N-type impurity with a low concentration on a surface of a bulk substrate made of silicon; opposing an N+ diffusion layer to a P+ diffusion layer with the N− diffusion layer interposed therebetween to form vertical photodiodes; forming a three-layered interlayer insulation film and a protective silicon nitride film on the photodiode; removing the protective film on the photodiode by an etching process; dividing the photodiodes into individual pieces; mounting the photodiode in a lead frame; performing wire bonding; and, sealing the photodiode with the light transmittable gel having the same refractive index as that of the interlayer insulation film and having the thickness of about 200 μm.

### INTRODUCTION TO THE INVENTION

Today, due to destruction of the ozone layer, more ultraviolet rays contained in sunlight contact human bodies now more than ever before. Generally, an ultraviolet ray is invisible light of an ultraviolet range of 400 nm or shorter wavelengths. The ultraviolet ray is classified into a long wave ultraviolet ray (UV-A wave: about 320 to 400 nm wavelengths), a medium wave ultraviolet ray (UV-B wave: about 280 to 320 nm wavelengths), and a short wave ultraviolet ray (UV-C wave: about 280 or shorter nm wavelengths). The impact upon humans and other objects upon which ultraviolet rays are shined is different depending on the wavelength ranges of the ultraviolet rays. That is, the UV-A wave may cause blackening and inner skin aging in humans. The UV-B wave may cause skin inflammation and a skin cancer in humans. The UV-C has a strong sterilizing action in humans. However, the UV-C is typically absorbed in the ozone layer and thus the vast majority does not reach earth's surface.

In order to protect a human body, rapid notification of the amount of irradiated ultraviolet rays is an important task. The UV index, which is an index measuring an amount of ultraviolet irradiation, was announced in 1995. The UV index is a relative influence grade that represents a degree of influence on a human body and can be calculated using the CIE (Commission Internationale de l'Eclairage) action spectrum defined by CIE. The UV index can be calculated by multiplying a light-receiving property of the UV-B wave at distinct points across the wavelength spectrum and integrating the result by the wavelength range of the UV-B wave. Accordingly, there is a need for an ultraviolet sensor capable of detecting the intensity of ultraviolet rays by separating the ultraviolet rays of two wavelength ranges, UV-A and UV-B. However, known ultraviolet sensors for the ultraviolet range of 400 nm or shorter wavelengths have been unable to separately detect UV-A and UV-B.

The instant disclosure addresses, at least in part, the shortcomings of the prior art to provide an ultraviolet sensor capable of separately detecting an amount of ultraviolet irradiation of two wavelength ranges, UV-A and UV-B. In exemplary form, an ultraviolet sensor includes: a pair of photodiodes in which each photodiode includes a high concentration P-type diffusion layer formed by diffusing a P-type impurity with a high concentration and a high concentration N-type diffusion layer formed by diffusing an N-type impurity with a high concentration, where each diffusion layer is formed in a first silicon semiconductor layer on an insulation layer, and are opposed to each other with a low concentration diffusion layer formed in a second silicon semiconductor layer thinner than the first silicon semiconductor layer, where the low concentration diffusion layer is formed by diffusing one of the P-type impurity or the N-type impurity with a low concentration, interposed therebetween; an interlayer insulation film that is formed on the first and second silicon semiconductor layers; a silicon nitride filter film that is formed on the interlayer insulation layer of one of the photodiodes and transmits rays of a wavelength range of a UV-A or a longer wavelength; and, a sealing layer that covers the interlayer insulation film of the other of the photodiodes and the filter film and transmits rays of a wavelength range of a UV-B wave or a longer wave.

According to the disclosure, there is provided an ultraviolet sensor capable of separately detecting an amount of ultraviolet irradiation of two wavelength ranges, including UV-A and UV-B. Since the visible rays passing through a sealing layer and a filter layer is cut by the thickness of a second silicon semiconductor layer, only the amount of UV-A irradiation can be output from one of photodiodes, and only the aggregate amount of UV-A and UV-B irradiation can be output from the other of the photodiodes.

In an aspect, an ultraviolet sensor may include a pair of photodiodes including a high concentration P-type diffusion layer formed by diffusing a P-type impurity and a high concentration N-type diffusion layer formed by diffusing an N-type impurity formed in a first silicon semiconductor layer on an insulation layer that are spaced apart from each other by a low concentration diffusion layer formed in a second silicon semiconductor layer thinner than the first silicon semiconductor layer, where the low concentration diffusion layer comprises one of the P-type impurity and the N-type impurity at a lower concentration than either of the high concentration P-type diffusion layer or the high concentration N-type diffusion layer; an interlayer insulation film formed over the first and second silicon semiconductor layers; a filter film formed over the interlayer insulation layer of one of the photodiodes, the filter film transmitting rays having a wavelength of put into a dependent claim nanometers or longer; and a sealing layer covering at least the interlayer insulation film of the other of the photodiodes the filter film, transmitting rays having a wavelength of put into a dependent claim nanometers or longer.

In a detailed embodiment, the second silicon semiconductor layer may have a thickness from 3 nanometers to 36 nanometers.

In a detailed embodiment, the filter film may include a silicon nitride film formed by a chemical vapor deposition process in which a flow ratio of monosilane to ammonia to nitrogen to argon is 1.0:7:3:1 under the condition of a temperature between 350° C. to 450° C. and a pressure between 4.0 Torr to 6.0 Torr. In a further detailed embodiment, the filter film may include a silicon nitride film formed by a chemical vapor deposition process in which a flow ratio of monosilane to ammonia to nitrogen to argon is 1.0:7:3:1 under the condition of a temperature between 350° C. to 450° C. and a pressure between 4.0 Torr to 6.0 Torr.

In a detailed embodiment, the sealing layer may include a silicon resin.

In an aspect, a method of manufacturing an ultraviolet sensor may include preparing a semiconductor wafer having an silicon-on-insulator structure; forming a pair of photodiodes by diffusing a P-type impurity with a high concentration to form a high concentration P-type diffusion layer and diffusing an N-type impurity with a high concentration to form a high concentration N-type diffusion layer, both the high concentration P-type diffusion layer and the high concentration N-type diffusion layer formed in a first silicon semiconductor layer on an insulation layer; forming a low concentration diffusion layer in a second silicon semiconductor layer thinner than the first silicon semiconductor layer by diffusing one of the P-type impurity or the N-type impurity with a low concentration, the low concentration diffusion layer interposing the high concentration P-type diffusion layer and the high concentration N-type diffusion layer; forming an interlayer insulation film over the first and second silicon semiconductor layers; forming a filter film over the interlayer insulation layer of one of the photodiodes, the filter film transmitting rays dependent claim or longer; and forming a sealing layer which covers the at least interlayer insulation film of the other of the photodiodes and filter film, the sealing layer film transmitting rays having a wavelength of dependent claim nanometers or longer.

In a detailed embodiment, the second silicon semiconductor layer has a thickness between 3 nanometers to 36 nanometers. In a detailed embodiment, the filter film comprises a silicon nitride film formed by a chemical vapor deposition process in which a flow ratio of monosilane to ammonia to nitrogen to argon is 1.0:7:3:1 under the condition of a temperature between 350° C. to 450° C. and a pressure between 4.0 Torr to 6.0 Torr.

In a detailed embodiment, the filter film comprises a silicon nitride film formed by a chemical vapor deposition process in which a flow ratio of monosilane to ammonia to nitrogen to argon is 1.0:7:3:1 under the condition of a temperature between 350° C. to 450° C. and a pressure between 4.0 Torr to 6.0 Torr.

In a detailed embodiment, the sealing layer may be formed of a silicon resin.

### BRIEF DESCRIPTION OF THE DRAWINGS

FIG. 1 is an explanatory diagram illustrating the upper surface of an ultraviolet sensor according to an exemplary embodiment.

FIG. 2 is an explanatory diagram illustrating a cross section of the ultraviolet sensor taken along lines A-A of FIG. 1.

FIG. 3 is an explanatory diagram illustrating certain steps of an exemplary method of manufacturing the ultraviolet sensor according to the embodiment of the invention.

FIG. 4 is an explanatory diagram illustrating certain steps of the exemplary method of manufacturing the ultraviolet sensor according to the exemplary embodiment.

FIG. 5 is an explanatory diagram illustrating certain steps of the exemplary method of manufacturing the ultraviolet sensor according to the exemplary embodiment.

FIG. 6 is an explanatory diagram illustrating an ultraviolet ray detecting package from side view according to the exemplary embodiment.

FIG. 7 is a graph illustrating an optical transmissivity property of a filter film according to the exemplary embodiment.

FIG. 8 is a graph illustrating a transmissivity of a UV-B wave which varies in accordance with the thickness of a filter film according to the exemplary embodiment.

FIG. 9 is a graph illustrating a spectral sensitivity of a photodiode when the thickness of a silicon semiconductor layer is 40.04 nm.

FIG. 10 is a graph illustrating a sub-peak wavelength varying in accordance with the thickness of the silicon semiconductor layer.

FIG. 11 is a graph illustrating a spectral sensitivity of one pair of photodiodes according to the exemplary embodiment.

FIG. 12 is a graph illustrating plane non-uniformity of the photodiodes in which a passivation film is removed according to the exemplary embodiment.

FIG. 13 is a graph illustrating plane non-uniformity of the photodiodes in which the passivation film is formed.

FIG. 14 is a graph illustrating plane non-uniformity of the photodiodes in which a filter film is formed according to the exemplary embodiment.

FIG. 15 is a graph illustrating an experiment result of a humidity resistance test of an ultraviolet detection package according to the exemplary embodiment.

### DETAILED DESCRIPTION

The exemplary embodiments are described and illustrated below to encompass ultraviolet sensors using a photodiode capable of receiving rays containing an ultraviolet ray and generating current, as well as exemplary methods of manufacturing an ultraviolet sensor. Of course, it will be apparent to those of ordinary skill in the art that the embodiments discussed below are exemplary in nature and may be reconfigured without departing from the scope and spirit of the disclosure. However, for clarity and precision, the exemplary embodiments as discussed below may include optional steps, methods, and features that one of ordinary skill should recognize as not being a requisite to fall within the scope of the disclosure.

Hereinafter, an ultraviolet sensor and a method of manufacturing an ultraviolet sensor will be described with reference to the drawings according to an exemplary embodiment of the disclosure.

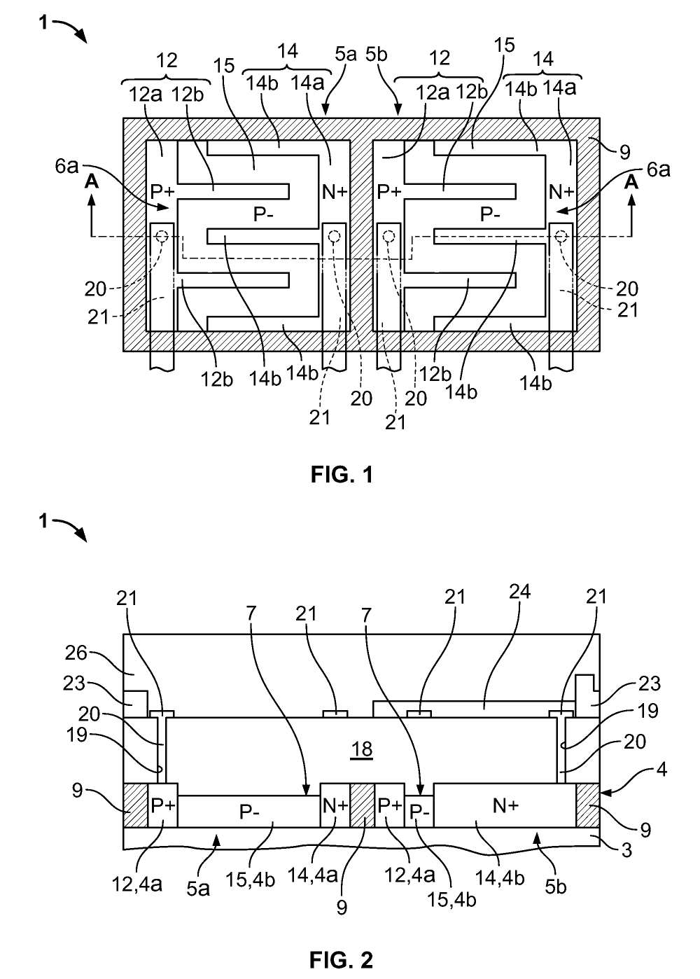

Referring to FIGS. 1 and 2, an ultraviolet sensor 1 includes a pair of horizontal PN junction photodiodes 5a, 5b formed on a silicon semiconductor layer 4 of a semiconductor wafer having a SOI structure. The silicon semiconductor layer 4 is formed of single crystalline silicon formed on a silicon (Si) substrate (not shown) with an implanted silicon dioxide (SiO₂) insulating film 3 interposed therebetween.

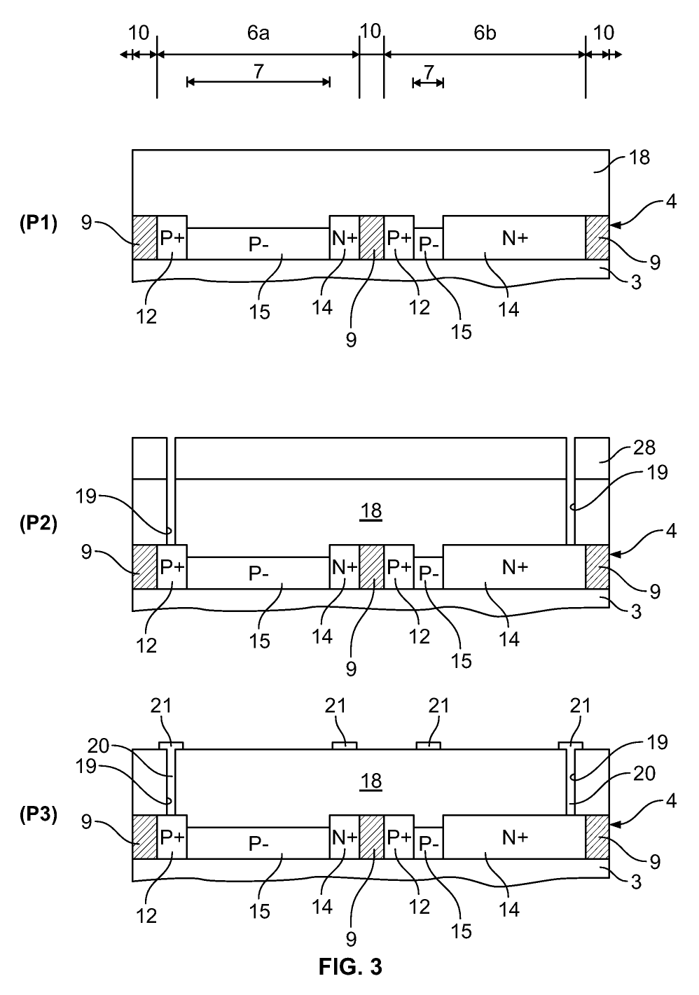

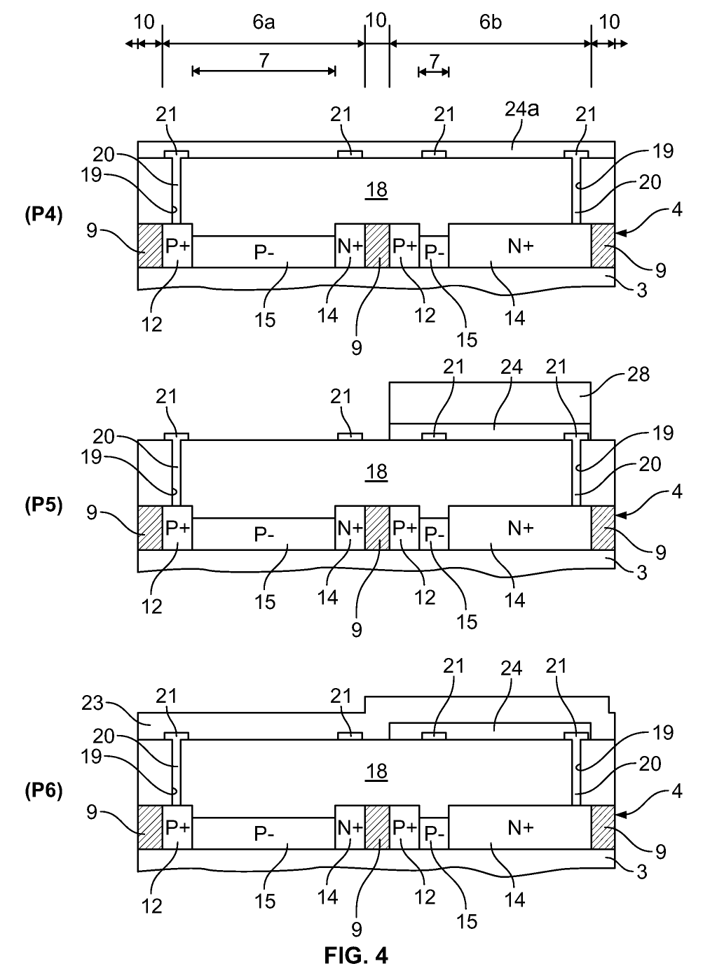

Referring to FIGS. 3 and 4, diode formation regions 6a, 6b for forming the photodiodes 5a, 5b of the ultraviolet sensor 1 are set to be adjacent to each other on the silicon semiconductor layer 4. In each of the diode formation regions 6a, 6b, there is a thinning region 7 for forming a second silicon semiconductor layer 4b (See FIG. 2) that is thinner than an original thickness of the silicon semiconductor layer 4 of the semiconductor wafer having the SOI structure. In the following description, the silicon semiconductor layer 4 regions, other than the second silicon semiconductor layers 4b of the thinning regions 7, are referred to as first silicon semiconductor layers 4a (see FIG. 2). When it is not necessary to distinguish the first silicon semiconductor layers 4a from the second silicon semiconductor layers 4b, the term “silicon semiconductor layer 4” is to refer to these layers in the alternative or in combination.

Referring again to FIGS. 3 and 4, Element separation regions 10 for forming element separation layers 9 are set in regions surrounding the diode formation regions 6a, 6b in the shape of a rectangular frame. The element separation layers 9 are formed of an insulating material, such as silicon dioxide in the silicon semiconductor layer 4 of the element separation regions 10 so as to reach the implanted oxide film 3, and have a function separating and electrically insulating the diode formation regions 6a, 6b.

Referring to FIGS. 1-4, in this exemplary embodiment, the element separation layers 9 are depicted pictorially by cross-hatching areas. The pair of photodiodes 5a, 5b are formed in the diode formation regions 6a, 6b set in the silicon semiconductor layer 4, respectively, so as to have the same configuration.

Referring to FIGS. 1-5, a P+ diffusion layer 12 is formed by diffusing a P-type impurity, such as boron (B) for example, at a relatively high concentration in the first silicon semiconductor layer 4a of each of the diode formation regions 6a, 6b. As shown in FIG. 1, each of the P+ diffusion layers 12 is formed in the pectinate shape by a rod portion 12a that contacts with one inner side of the element separation layer 9 and plural comb portions 12b extending from the rod portion 12a. In this exemplary embodiment, each of the P+ diffusion layers 12 is formed in the shape of “π” by extending two comb portions 12b from the rod portion 12a.

A N+ diffusion layer 14 comprises a high concentration N-type diffusion layer, which is a diffusion layer contrary to the high concentration P-type diffusion layer, is formed by diffusing an N-type impurity at a relatively high concentration, such as phosphorus (P) or arsenic (As) for example, in the first silicon semiconductor layer 4a of each of the diode formation regions 6a, 6b. As shown in FIG. 1, each of the N+ diffusion layers 14 is formed in the pectinate shape by a rod portion 14a that contacts with the opposing inner side of the element separation layer 9 and plural comb portions 14b extending from the rod portion 14a. In this exemplary embodiment, the N+ diffusion layer 14 is formed in the shape of “E” by extending three comb portions 14b from both ends and the middle of the rod portion 14a.

A P− diffusion layer 15 comprising a low concentration diffusion layer is formed in each of the diode formation regions 6a, 6b by diffusing the P-type impurity with a relatively low concentration in the second silicon semiconductor layer 4b that contacts the P+ diffusion layer 12 and the N+ diffusion layer 14 and in which the comb portions 12b, 14b are opposed to each other so as to separately engage with each other. The P− diffusion layer 15 is a portion in which electron-hole pairs are generated by ultraviolet rays absorbed in a depletion layer formed the P− diffusion layer. In order to form the second silicon semiconductor layer 4b having a relatively thin thickness, the P− diffusion layer 15 interposes the P+ diffusion layer 12 having the shape of “π” and the N+ diffusion layer 14 having the shape of “E” is formed in each of the diode formation regions 6a, 6b and set to the thinning region 7.

An interlayer insulation film 18 comprises an insulation film formed on the first and second silicon semiconductor layers 4a, 4b. The interlayer insulation film is comprised of silicon dioxide silicon or NSG (Non-doped Silica Glass), for example, which allows passage therethrough of an ultraviolet ray having wavelengths ranges within UV-A or UV-B and a visible ray, that is, rays having the wavelength ranges of the UV-B wave or high waves so as to have about 4000 nm.

A contact hole 19 comprises a through-hole formed in a region for forming contact plugs 20 of the photodiodes 5a, 5b in the interlayer insulation film 18 and reaching the P+ diffusion layer 12 and the N+ diffusion layer 14. Each of the contact plugs 20 is formed by implanting a conductive material such as, without limitation, aluminum (Al), tungsten (W), or titanium (Ti) within the contact hole 19.

A circuit wiring 21 is formed on the interlayer insulation film 18 by etching a wiring layer formed of the same conductive material, for example, as that of the contact plug 20. As illustrated by two dashed lines of FIG. 1, the circuit wirings 21 are disposed so as not pass though the P− diffusion layers 15 in order to inhibit reception of sun rays and are electrically connected to the P+ diffusion layer 12 and the N+ diffusion layer 14 through the contact plugs 20.

A protective passivation film 23 comprising, for example, silicon nitride (Si₃N₄), is disposed on the interface insulation film 18. The passivation film 23 functions to protect a peripheral circuit formed by the circuit wirings 21, a MOSFET (Metal Oxide Semiconductor Field Effect Transistor), and the like from external humidity or the like. In this exemplary embodiment, the passivation film 23 disposed on the pair of photodiodes 5a, 5b is removed in order to improve permeability of light.

A silicon nitride filter film 24 comprises a single layer formed on the interlayer insulation film 18. The filter film 24 is formed so as to be opposed to at least one (the photodiode 5b in this exemplary embodiment) of the pair of photodiodes 5a, 5b with the interlayer insulation film 18 interposed therebetween and formed so as to have the same size of that of the diode formation region 6b. In this exemplary embodiment, the filter film 24 serves as a filter that inhibits ultraviolet rays having a wavelength in the UV-B region, as well as visible rays, while at the same time allowing ultraviolet rays having wavelength in the UV-A region or longer to pass therethrough.

A protective sealing layer 26 is formed by heating and hardening an ultraviolet transmission silicon sealing resin transmitting rays of wavelength ranges of the UV-B wave or longer waves. The sealing layer 26 functions to protect the photodiodes 5a, 5b from external humidity or the like. In this exemplary embodiment, an exemplary silicon resin for use as the sealing layer 26 may have excellent weather resistance against humidity, ultraviolet rays, or the like. The hardness of the ultraviolet transmission sealing resin subjected to the hardening is in the range of about 30 to 70 in the Shore A hardness scale.

Referring specifically to FIGS. 3 and 4, a resist mask 28 is applied on the silicon semiconductor layer 4 by a photolithography process and formed by performing an exposure process and a development process on a positive or negative mask member. The resist mask 28 serves as a mask in an etching process or an ion implantation process according to this embodiment.

Referring to FIG. 4, the filter film 24 is formed by a silicon nitride film 24a containing significant hydrogen (H). The silicon nitride film 24a may be formed by a CVD (Chemical Vapor Deposition) process, for example, in which a flow ratio of monosilane (SiH₄) to ammonia (NH₃) to nitrogen (N₂) to argon (Ar) is 1.0:7:3:1 under temperatures from approximately 350° C. to 450° C. and pressures from approximately 4.0 Torr to 6.0 Torr.

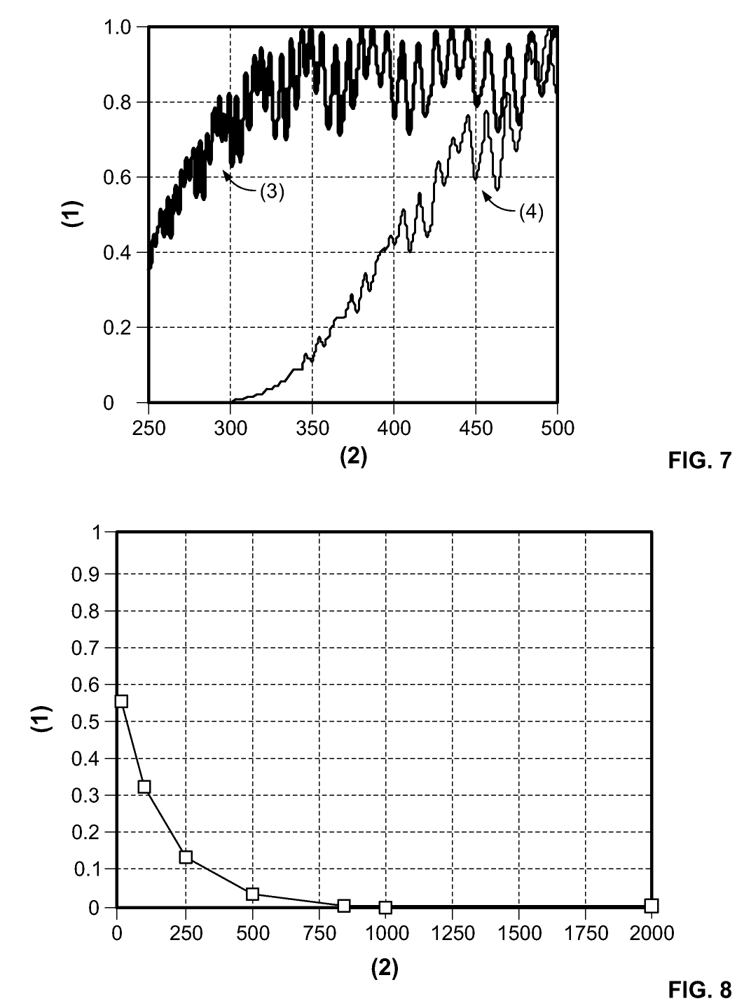

Referencing FIG. 7, a graph illustrating an optical transmissivity property of the hydrogen rich silicon nitride film 24a is shown. That is, a transmissivity of a wavelength in the range of about a 280 nm (which is the lowest wavelength of UV-B) or a longer wavelength is 60% or more in comparison to a hydrogen depleted silicon nitride film (approximately 850 nm in film thickness). However, a wavelength in the range of about 320 nm (which is the lowest wavelength of UV-A) or a shorter wavelength is blocked by the filter film 24 (approximately 850 nm in film thickness) formed by the hydrogen rich silicon nitride film 24a. The degree of absorption of the UV-B wave depends, at least in part, on an amount of hydrogen contained in the silicon nitride film. The comparison depleted hydrogen silicon nitride film is formed by a CVD process in which the flow ratio of monosilane to ammonia to nitrogen to argon is 0.3:7:3:1 under the same conditions of temperature and pressure as were used to form the hydrogen rich silicon nitride film.

The reason why the absorption property of the ultraviolet rays in the UV-B region changes in accordance with the amount of hydrogen contained in the silicon nitride film is that since a bond energy (N—H bond energy) of hydrogen and nitrogen contained in the silicon nitride film corresponds to an energy of the UV-B wavelength range (about 300 nm), energy is absorbed at the time of breaking up the N—H bond by the energy of the UV-B wave and thus the UV-B ray is lost. Accordingly, the UV-B wave cannot pass through the filter film 24 in this embodiment.

As shown in FIG. 8, the transmissivity of the UV-B wave in the filter film 24 varies in accordance with the film thickness. The transmissivity increases as the film thickness is thinner. Accordingly, in this embodiment, the film thickness of the filter film 24 is set to approximately 250 nm, otherwise the transmissivity of the UV-B wave would be excessive.

In addition, the film thickness of the interlayer insulation film 18 is not particularly limited, but the film thickness should be sufficient to ensure an adequate insulating property. An extinction coefficient of the interlayer insulation film 18 is “0” and does not affect the optical absorption property.

Since the filter film 24 and the sealing layer 26 transmit the visible rays in this exemplary embodiment, the visible ray component should be removed in order to obtain adequately measure the ultraviolet rays from the pair of photodiodes 5a, 5b. As a result, the exemplary embodiment provides a means to selectively detect ultraviolet rays. That is, in part, obtained by using a thickness of the silicon semiconductor layer 4 that does not respond to the wavelength range of visible rays.

An optical absorption ratio in silicon is expressed by Beer's Law. When a wavelength in which the optical absorption ratio is 10% in the thickness of the silicon semiconductor layer 4, the thickness of the silicon semiconductor layer 4 having a selective sensitivity in the ultraviolet area of a 400 nm or less is calculated to 50 nm or less. The exemplary embodiment includes forming a photodiode mounted with the P+ diffusion layer 12, the N+ diffusion layer 14, and the P− diffusion layer 15 which is not subjected to a thinning process (i.e., thickness change in a range of 50 nm or less) on the silicon semiconductor layer 4 and experimentally measuring spectral sensitivities of the wavelengths on the basis of the calculation result.

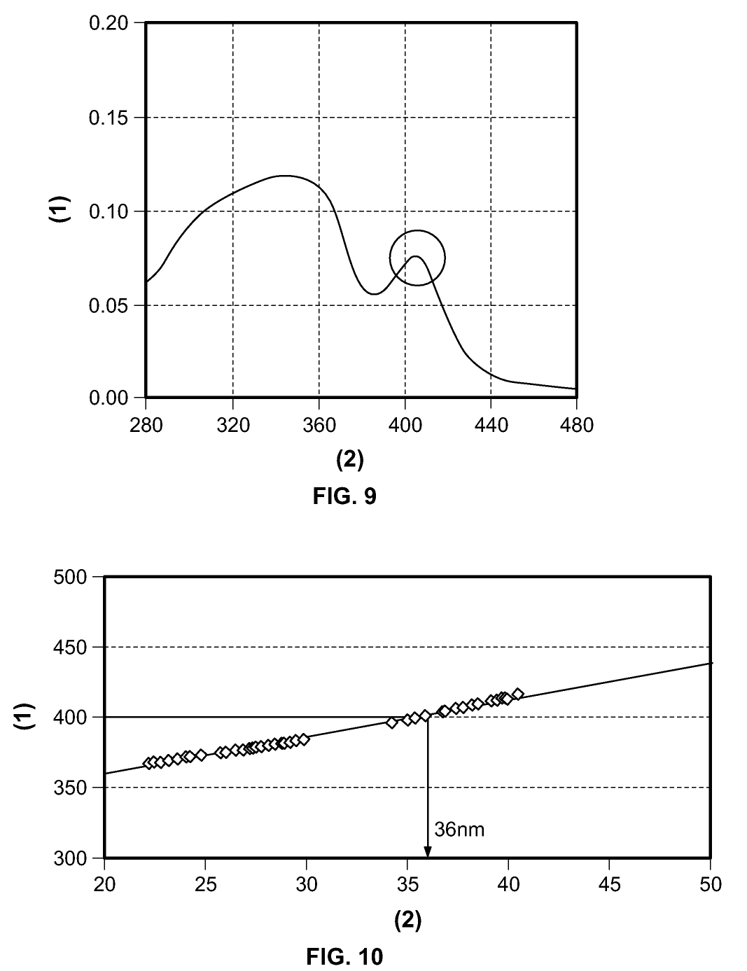

Referring to FIG. 9, a graph illustrates the spectral sensitivity of the photodiode when the thickness of the silicon semiconductor layer 4 is 40.04 nm. In a photodiode in which the thickness of the silicon semiconductor layer 4 is about 40 nm, a sub-peak (indicated by a circle in FIG. 9) is present in the wavelength range (violet) of the visible ray that is longer than the wavelength range (the wavelength range of a 400 nm or less wavelength) of the ultraviolet ray. The reason for this is because the measurement experiment was carried out on the assumption that rays pass through the silicon semiconductor layer 4 without any change. But, in fact, the rays are reflected on an interface between the silicon semiconductor layer 4 and the implanted oxide film 3 in the actual photodiode, so the rays react to the visible ray having a wavelength longer than the wavelength of the ultraviolet ray due to the lengthened passage through which the rays pass, and thus the sub-peak appears. Such a sub-peak also appears in the thinner silicon semiconductor layer 4. The result of the appearing wavelength (referred to as a sub-peak wavelength) obtained by way of experiment is shown in FIG. 10.

In FIG. 10, the sub-peak wavelength is shortened as the thickness of the silicon semiconductor layer 4 is thinner. On the assumption that the thickness of the silicon semiconductor layer 4 is Tₛᵢ (in nanometers, nm) and the sub-peak wavelength is Lₛ (unit in nanometers, nm), the sub-peak wavelength is approximated by the following experimental expression:

Ls=2.457Tsi+312.5 (1)

The thickness of the silicon semiconductor layer 4 is set to 36 nm or less in order not to react to the visible ray having the wavelength longer than the 400 nm, while avoiding the influence of the reflection at the interface between the silicon semiconductor layer 4 and the implanted oxide film 3. Accordingly, it is preferable that the thickness of the second silicon semiconductor layer 4b that selectively detects only the ultraviolet area, without reaction to the visible ray passing though the filter film 24 and the sealing layer 26, is set to approximately 36 nm or less, with the thinnest thickness being approximately 3 nm. In this exemplary embodiment, the thickness of the second silicon semiconductor layer 4b is set to 35 nm. In addition, the thickness of the first silicon semiconductor layer 4a is set between approximately 40 nm to 100 nm (50 nm in this embodiment) in order to suppress increases in the sheet resistance of the P+ diffusion layer 12 and the N+ diffusion layer 14 and to ensure operation of the MOSFET of the peripheral circuit (not shown).

Referencing FIGS. 3-5, manufacturing the exemplary ultraviolet sensor 1 starts with a silicon semiconductor layer 4 having a thickness of approximately 50 nm by forming a sacrificial oxide film over the implanted oxide film 3 of the semiconductor wafer. In this exemplary embodiment, the semiconductor wafer has a silicon-on-insulator (SOI) structure in which a thin silicon layer remains on the implanted oxide film 3 by a SIMOX (Separation by Implanted Oxygen) process, or of the semiconductor wafer, which has the SOI structure in which the thin silicon layer is attached onto the implanted oxide film 3, and removing the sacrifice oxide film an etching process.

The semiconductor layer 4 is formed to have approximately a 50 nm thickness using conventional techniques. Thereafter, element separation layers 9 are formed of silicon dioxide that reach the implanted oxide film 3 on the element separation regions 10 of the silicon semiconductor layer 4 by a LOCOS (Local Oxidation of Silicon) process.

P-type impurity ions are implanted with a low concentration in the silicon semiconductor layer 4 (the first silicon semiconductor layers 4a) of the diode formation regions 6a, 6b to form low concentration P-type implanted layers. A resist mask (not shown) is formed using conventional photolithographic techniques to expose formation regions (which are portions in the shape of “E” shown in FIG. 1) of the respective N+ diffusion layers 14 of the diode formation regions 6a, 6b. N-type impurity ions are implanted with a high concentration onto the exposed first silicon semiconductor layers 4a to form respective high concentration N-type implanted layers.

Subsequently, the foregoing resist mask is removed and another resist mask 28 is formed using conventional photolithographic techniques to expose formation regions (which are portions in the shape of “π” shown in FIG. 1) of the respective P+ diffusion layers 12 of the diode formation regions 6a, 6b. The P-type impurity ions are implanted with a high concentration onto the exposed first silicon semiconductor layers 4a to form respective high concentration P-type implanted layers.

The foregoing resist mask is removed and the impurities implanted in the respective implanted layers formed in the formation regions of the diffusion layers are activated by a thermal process to diffuse the impurities within the diffusion layers. Accordingly, the thermal process completes formation of the P+ diffusion layer 12, the N+ diffusion layer 14, and the P− diffusion layer 15 in each of the diode formation regions 6a, 6b. Thereafter, Nondoped Silica Glass (NSG) is accumulated on the entire surface of the silicon semiconductor layer 4 by a CVD process to form an insulating layer. Another resist mask (not shown) is formed on the NSG layer by conventional photolithography techniques to expose thinning regions 7 that are subsequently anisotropicly etched to form openings exposing the first silicon semiconductor layers 4a of the thinning regions 7.

Subsequently, the foregoing resist mask is removed and the exposed first silicon semiconductor layers 4a are etched, using the NSG layer as a mask, by a dry etching process that selectively etches silicon to allow the thickness of the first silicon semiconductor layers 4a to be thinned to the thickness (35 nm in this exemplary embodiment) of the second silicon semiconductors 4b in the thinning regions 7. Accordingly, the thinned P− diffusion layers 15 are formed in the second silicon semiconductor layers 4b. Thus, there is prepared a semiconductor wafer having the SOI structure in which the plural ultraviolet sensors 1, including one pair of horizontal PN junction photodiodes 5a, 5b having the same configuration on the silicon semiconductor layer 4, are formed.

Referring specifically to FIG. 3A, NSG is accumulated on the entire surface of the silicon semiconductor layer 4 by a CVD process and thereafter the upper surface of the silicon semiconductor layer 4 is subjected to a flattening process to form the interlayer insulation film 18.

Referring to FIG. 3B, a resist mask 28 includes openings formed using conventional photolithographic techniques to expose the interlayer insulation film 18 in the formation regions to define contact openings that when subjected to anisotropic etching, result in the contact holes 19 extending to the P+ diffusion layer 12 and the N+ diffusion layer 14 of the photodiodes 5a, 5b.

Referring to FIG. 3C, the resist mask 28 is removed and a conductive material is formed to occupy the contact holes 19 by a sputter process or other conventional process for forming contact plugs 20. Concurrent with contact plug 20 formation is the formation of wirings 21 on the interlayer insulation film 18 using the same conductive material as that of the contact plugs 20. The resist mask (not shown) covering formation regions of the wirings 21 is formed on the wiring layers by a conventional photolithography process, and thereafter the wiring layers are etched using the resist mask to form the wirings 21 that electrically connect the contact plugs 20. Thereafter, resist mask is removed.

Referring to FIG. 4A, a 250 nm silicon nitride film 24a, rich in hydrogen, is formed over the interlayer insulation film 18 and the wirings 21 using a conventional CVD process.

Referencing FIG. 4B, a resist mask 28 is formed that covers the diode formation region 6b over the silicon nitride film 24a by a conventional photolithography process. Thereafter, an anisotropic etching process is utilized to etch through the silicon nitride film 24a to expose the interlayer insulation film 18 and the wirings 21 of the region other than the diode formation region 6b. In this way, the filter film 24 having the same size as that of the diode formation region 6b, and being opposed to the photodiode 5b (see FIG. 2) with the interlayer insulation film 18 interposed therebetween, is formed.

Referring to FIG. 4C, the foregoing resist mask 28 is removed and a 300 nm thick silicon nitride passivation film 23 is formed over the interlayer insulation film 18, the wirings 21, and the filter film 24 by a conventional CVD process.

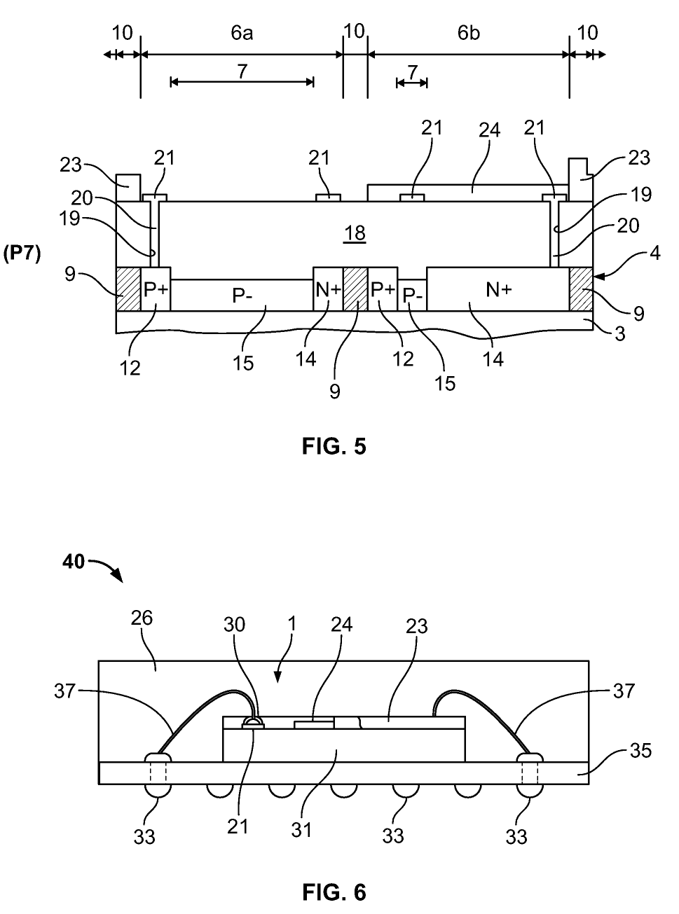

Referencing FIG. 5, a resist mask (not shown) exposing the diode formation regions 6a, 6b and the element separation regions 10 is formed over the passivation film 23 by a conventional photolithography process. Thereafter, the passivation film 23 is wet etched using the resist mask to expose the interlayer insulation film 18, the wirings 21, and the filter film 24 of the diode formation regions 6a, 6b.

Subsequently, the foregoing resist mask is removed, and another resist mask, (not shown) having openings therethrough in formation regions where terminal holes 30 will be located and expose the wirings 21, is formed by a conventional photolithography process. The passivation film 23 is etched by an anisotropic etching process to form the terminal holes 30 (see FIG. 6), and then the semiconductor wafer is divided into individual pieces. The resulting integrated circuit includes an ultraviolet sensor 1, where the filter film 24 is formed over one of the photodiodes 5b (see FIG. 2), while the other of the photodiodes 5a remains exposed, with the interlayer insulation film 18 interposing the photodiodes 5a, 5b, thereby forming a completed peripheral circuit (not shown).

Referring to FIG. 6, an ultraviolet detection package 40 is formed by joining the photo IC 31, which includes the ultraviolet sensor 1 according to the exemplary embodiment, to a ceramics substrate 35 having plural external terminals 33 formed from a silver paste or the like. The external terminals 33 electrically connect the wirings 21 exposed to the terminal holes 30 using wires 37. Thereafter, an ultraviolet transmission sealing resin (silicon resin in this exemplary embodiment) is injected into a peripheral portion containing the upper portion of the photo IC 31 on the ceramics substrate 35. Subsequently, the sealing resin is heated and hardened to form the sealing layer 26 having the thickness ranging generally between 200 μm to 300 μm, followed by detaching the ultraviolet detection package 40 from the frame.

One pair of photodiodes 5a, 5b formed in this way have the P-diffusion layers 15 formed in the second silicon semiconductor layer 4b with thicknesses ranging generally between 3 nm to 36 nm (35 nm in this exemplary embodiment) and are operative to transmit visible rays and higher wavelength rays (400 nm or more). Accordingly, the photodiodes do not react to the visible ray.

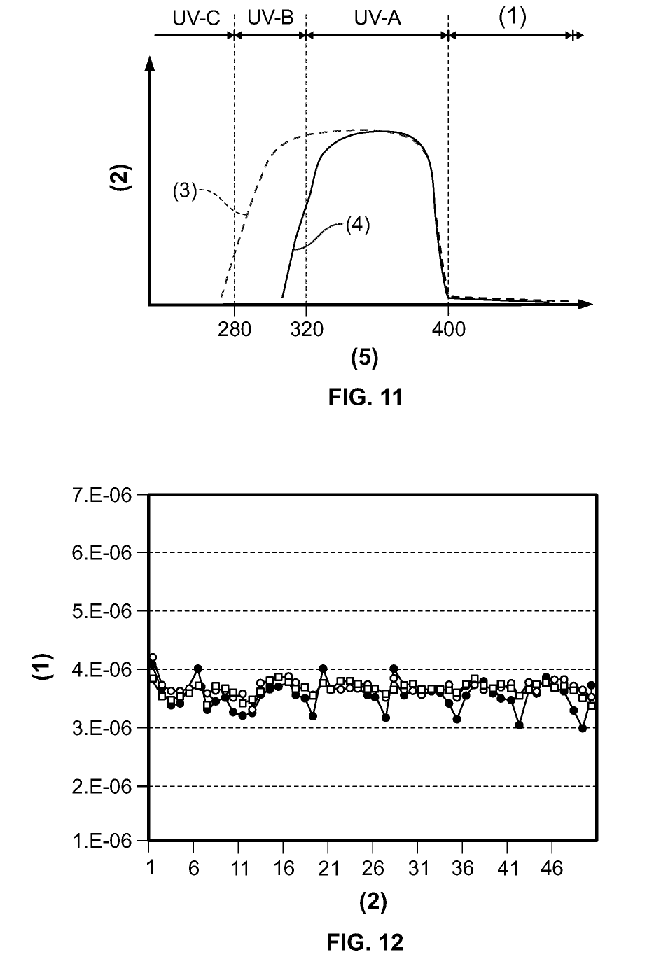

In this exemplary embodiment, the interlayer insulation film 18 that transmits the ultraviolet rays of the UV-A and UV-B wavelength ranges and the sealing layer 26 formed of the ultraviolet transmission resin are formed on the photodiode 5a. Accordingly, as shown in FIG. 11, visible rays are inhibited from passing through the thickness of the second silicon semiconductor layer 4b, thus only ultraviolet irradiations of the UV-A and UV-B wavelength ranges is detected.

The filter film 24, which is operative to inhibit visible rays from passing therethrough and allows rays of the UV-A wavelength to pass therethrough, is formed on the photodiode 5b. Accordingly, as shown in FIG. 11, only the amount of the ultraviolet irradiation of the UV-A wavelength is detected.

Accordingly, it is possible to obtain an ultraviolet sensor 1 capable of calculating the amount of ultraviolet irradiation within the UV-A wavelength by using the UV-B amount detected by the photodiode 5b and subtracting this amount from the amount of the ultraviolet irradiation detected in the UV-A and UV-B wavelengths by the photodiode 5a. As a result, the ultraviolet sensor 1 is operative to concurrently determine the individual amounts of the UV-A and UV-B irradiation.

In this exemplary embodiment, since the thin passivation film 23 is removed and then a relatively thick sealing layer 26 is formed on the photodiode 5a, it is possible to suppress a variation in the transmissivity caused due to non-uniformity of the thickness of the sealing layer 26 formed on the photo IC 31 at the time of manufacture.

As shown in FIG. 12, the non-uniformity between semiconductor wafers can be suppressed while suppressing a degree of non-uniformity of photoelectric current in the plural photodiodes 5a formed in one semiconductor wafer within a maximum of 1×10⁻⁶ A. Accordingly, it is possible to stabilize the quality of the photodiode 5a formed in the ultraviolet sensor 1. In FIGS. 12-14, horizontal axes represent locations within the plane of the photo IC 31 formed in one semiconductor wafer.

In this case, the reason for removing the silicon nitride passivation film 23 from the photodiode 5a is that the N—H bond present in the silicon nitride film needs to be reduced in order to ensure permeability of UV-B rays. As described above, it is difficult to uniformly distribute hydrogen when the silicon nitride film, having a small amount of hydrogen, is formed in the semiconductor wafer. Accordingly, the quality of the photodiode 5a cannot be stabilized since an optical constant constituted by a refractive index and an extinction coefficient is distributed in the plane.

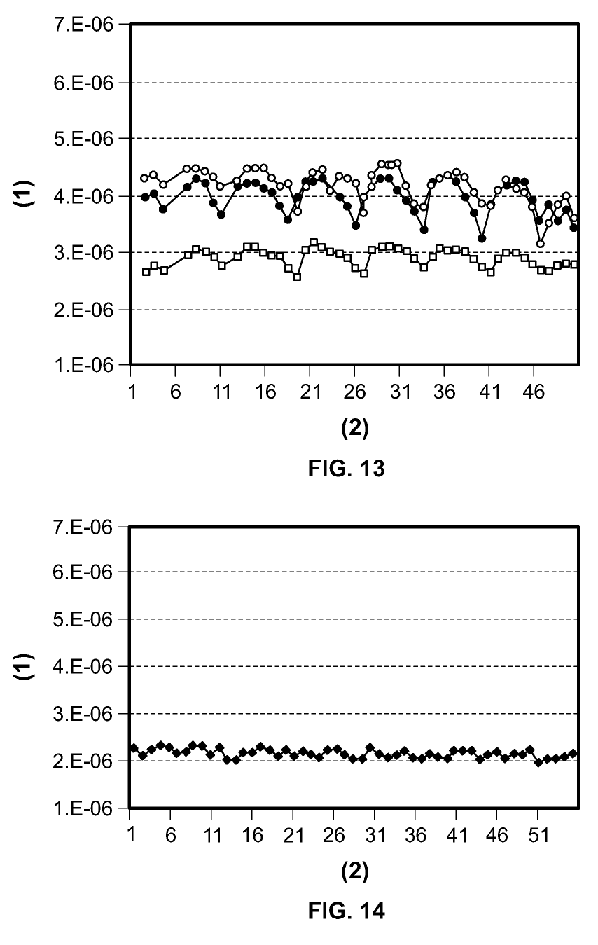

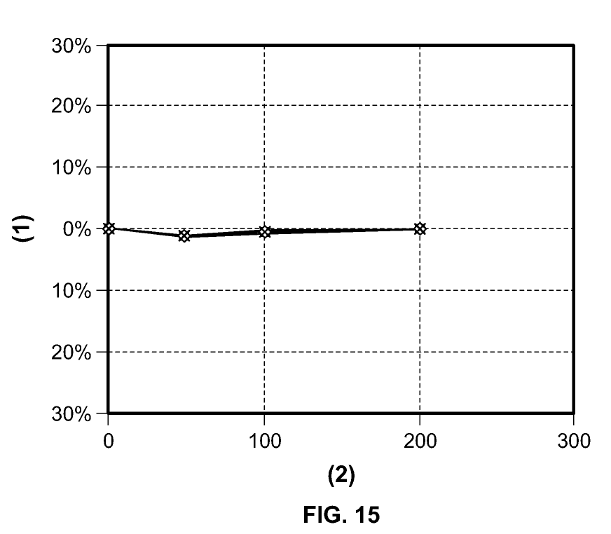

Referring to FIG. 13, for example, when the silicon nitride film with a small amount of hydrogen is used as the passivation film 23 on the photodiode 5a, the degree of non-uniformity of the photoelectric current in the photodiodes 5a formed in one semiconductor wafer is the maximum of 1.5×10⁻⁶ A. Accordingly, the non-uniformity also occurs between the semiconductor wafers.

Referencing FIG. 14, in this exemplary embodiment, since the filter layer 24, which includes a significant amount of hydrogen, is formed on the interlayer insulation film 18 on the photodiode 5b, it is possible not to transmit the ultraviolet ray of the UV-B wavelength range because the N—H bond is broken by the energy of the UV-B wave. As shown in FIG. 14, it is possible to stabilize the quality of the photodiode 5b formed in the ultraviolet sensor 1 by suppressing the degree of non-uniformity of the photoelectric current in the plural photodiodes 5b formed in one semiconductor wafer within a maximum of 0.4×10⁻⁶ A. In this case, the reason for configuring the filter film 24 as a single layer is to prevent the transmissivity from being reduced due to dispersion of incident light caused by the reflection in an interface of each layer when plural layers having different refractive indexes are laminated. In this exemplary embodiment, the filter film 24 is formed on the flattened interlayer insulation film 18. Accordingly, it is possible to allow the thickness of the filter film 24 to be uniform.

In this exemplary embodiment, as described above, the passivation film 23 functioning to protect against humidity or the like is removed from the photodiodes 5a, 5b of the ultraviolet sensor 1. However, the ultraviolet detection package 40 is sealed by a silicon resin sealing layer 26 having excellent humidity resistance. Accordingly, a variation ratio of the output voltage of the ultraviolet detection package 40 is within 2% even in a humidity resistance acceleration test. In exemplary form, the humidity resistance acceleration test comprises a Pressure Cooker Test performed under the conditions: temperature of 121° C., pressure of 2 atm, and duration of 200 hours.

In this exemplary embodiment, as described above, the ultraviolet sensor includes: a pair of photodiodes in which a high concentration P-type diffusion layer is formed by diffusing a P-type impurity with a high concentration and a high concentration N-type diffusion layer is formed by diffusing an N-type impurity with a high concentration, both of which are formed in a first silicon semiconductor layer on an insulation layer and are opposed to each other and interposed by a low concentration diffusion layer formed in a second silicon semiconductor layer thinner than the first silicon semiconductor layer by diffusing one of the P-type impurity or the N-type impurity at a lower concentration; a silicon nitride filter film formed on the interlayer insulation layer of one of the photodiodes and operative to transmit rays of UV-A or longer wavelengths; and, a sealing layer which covers the interlayer insulation film of the other of the photodiodes and the filter film and transmits rays having a UV-B or longer wavelength. With such a configuration, visible rays passing through the sealing layer and the filter layer are inhibited from further transmission by the thickness of the second silicon semiconductor layer. As a result, only the ultraviolet rays having a UV-A wavelength are detected by a first photodiode, while only ultraviolet rays having either a UV-A or UV-B wavelength are detected by the other photodiode. Accordingly, it is possible for the ultraviolet sensor to determine the individual amounts of UV-A and UV-B shown on the ultraviolet sensor 1.

By setting the thickness of the second silicon semiconductor layer to the range from 3 nm to 36 nm, it is possible to obtain photodiodes capable of selectively detecting only ultraviolet rays without the influence of the reflection at the interface between the silicon semiconductor layer and the implanted oxide film.

In the above-described embodiment, one pair of photodiodes of the ultraviolet sensor 1 is formed so the photodiodes are adjacent to each other. However, the photodiodes need not be adjacent to each other, but may be spaced apart within the photo IC.

In the above-described exemplary embodiment, the low concentration diffusion layer is formed by diffusing the P-type impurity. However, the same advantage may be obtained even when the low concentration diffusion layer is formed by diffusing the N-type impurity at a relatively low concentration.

In addition, in the above-described embodiment, the P+ diffusion layer and the N+ diffusion layer are formed in the shape of “π” and the shape of “E”, respectively. However, the diffusions layers may have other shapes, such as the P+ diffusion layer having an “E” shape and the N+ diffusion layer having a “π” shape. In addition, it is also within the scope of the disclosure to provide multiple comb portions.

In the above-described exemplary embodiment, the P+ diffusion layer and the N+ diffusion layer are formed so as to include comb portions that engage one another. However, it is not necessary to form comb portions that are opposed to each other. Other shapes may be utilized with a low concentration diffusion layer interposed therebetween.

In the above-described exemplary embodiment, the semiconductor wafer has an SOI structure. However, the disclosure is not limited to a semiconductor wafer having the SOI structure. For example, the SOI structure may be formed over an SOS (Silicon On Sapphire) substrate or over an SOQ (Silicon On Quartz) substrate.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

1. An ultraviolet sensor comprising:
a pair of photodiodes including a high concentration P-type diffusion layer formed by diffusing a P-type impurity and a high concentration N-type diffusion layer formed by diffusing an N-type impurity formed in a first silicon semiconductor layer on an insulation layer that are spaced apart from each other by a low concentration diffusion layer formed in a second silicon semiconductor layer thinner than the first silicon semiconductor layer, where the low concentration diffusion layer comprises one of the P-type impurity and the N-type impurity at a lower concentration than either of the high concentration P-type diffusion layer or the high concentration N-type diffusion layer;
an interlayer insulation film formed over the first and second silicon semiconductor layers;
a filter film formed over the interlayer insulation layer of one of the photodiodes, the filter film transmitting rays having a wavelength of put into a dependent claim nanometers or longer; and
a sealing layer covering at least the interlayer insulation film of the other of the photodiodes the filter film, transmitting rays having a wavelength of put into a dependent claim nanometers or longer.

2. The ultraviolet sensor according to claim 1, wherein the second silicon semiconductor layer has a thickness from 3 nanometers to 36 nanometers.

3. The ultraviolet sensor according to claim 1, wherein the filter film comprises a silicon nitride film formed by a chemical vapor deposition process in which a flow ratio of monosilane to ammonia to nitrogen to argon is 1.0:7:3:1 under the condition of a temperature between 350° C. to 450° C. and a pressure between 4.0 Torr to 6.0 Torr.

4. The ultraviolet sensor according to claim 2, wherein the filter film comprises a silicon nitride film formed by a chemical vapor deposition process in which a flow ratio of monosilane to ammonia to nitrogen to argon is 1.0:7:3:1 under the condition of a temperature between 350° C. to 450° C. and a pressure between 4.0 Torr to 6.0 Torr.

5. The ultraviolet sensor according to claim 1, wherein the sealing layer comprises a silicon resin.

6. The ultraviolet sensor according to claim 2, wherein the sealing layer comprises a silicon resin.

7. The ultraviolet sensor according to claim 3, wherein the sealing layer comprises a silicon resin.

8. The ultraviolet sensor according claim 4, wherein the sealing layer comprises a silicon resin.

9. The ultraviolet sensor according to claim 5, wherein the sealing layer comprises a silicon resin.
